(19) United States
(12) Patent Application Publication
(10) Pub. No.: US 2023/0419145 A1
(43) Pub. Date: Dec. 28, 2023

(54) PROCESSOR AND METHOD FOR PERFORMING TENSOR NETWORK CONTRACTION IN QUANTUM SIMULATOR

(71) Applicant: HUAWEI TECHNOLOGIES CO., LTD., Shenzhen (CN)

(72) Inventors: Pavel Anatolyevich Panteleev, Munich (DE); Gleb Vyacheslavovich Kalachev, Munich (DE); Dingshun Lv, Shenzhen (CN); Manhong Yung, Shenzhen (CN)

(21) Appl. No.: 18/462,189

(22) Filed: Sep. 6, 2023

Related U.S. Application Data
(63) Continuation of application No. PCT/RU2021/000134, filed on Mar. 30, 2021.

(51) Int. Cl. G06N 10/20; G06N 10/60

(52) U.S. Cl. CPC G06N 10/20; G06N 10/60

(57) ABSTRACT

The present disclosure relates to the field of quantum computing, and in particular to simulating quantum circuits with a quantum simulator. The disclosure presents a processor for a quantum simulator. The processor is configured to perform a local search algorithm to determine a plurality of contraction expressions suitable to contract a respective tensor network into a determined contracted tensor network. The processor is further configured to determine, for each contraction expression, a contraction cost for contracting the respective tensor network based on a cost function, and to select the contraction expression with the lowest contraction cost to contract each tensor network into the determined contracted tensor network. The cost function is based on three parameters, which respectively indicate a required memory amount, a computational complexity, and a number of read-write operations required for contracting the respective tensor network into the determined contracted tensor network.

### CROSS-REFERENCE TO RELATED APPLICATIONS

This application is a continuation of International Application No. PCT/RU2021/000134, filed on Mar. 30, 2021, the disclosure of which is hereby incorporated by reference in its entirety.

### TECHNICAL FIELD

The present disclosure relates to the field of quantum computing, in particular, to the task of simulating quantum circuits using a quantum simulator. The disclosure presents a processor for such a quantum simulator, wherein the processor is configured to perform a contraction of one or more tensor networks into a determined contracted tensor network. The disclosure also presents the quantum simulator, which comprises the processor, and can use the tensor network contraction performed by the processor during a simulation and/or a verification of a quantum circuit.

### BACKGROUND

Conventional quantum simulators are used for simulating and/or verifying quantum circuits. In particular, the conventional quantum simulator may be used to find single amplitudes or batches of amplitudes of samples produced by the quantum circuit when run on a quantum system. A batch of amplitudes is a collection of bit strings that share some fixed bits.

However, many quantum simulation tasks require to find very large sets of random amplitudes or batches of amplitudes. For example, the verification task for Google's Sycamore 53 qubits Random Quantum Circuits (RQC) experiment, which was used to demonstrate quantum supremacy, requires to find ˜10⁶ random amplitudes per quantum circuit. In particular, the verification task requires finding the exact amplitudes for random samples produced by multiple quantum circuits run on a quantum system of a 53 qubits chip (as illustrated in FIG. 1).

Given an n-qubit quantum circuit C represented by its unitary operator, the expression p_{C}(s)=| [symbol] s|C|0ⁿ [symbol] |² denotes the probability of the bit string s∈{0, 1}ⁿ. The found probabilities of the bit strings can be used to estimate the fidelity of the quantum system. In Google's quantum computational supremacy experiment, the Linear Cross-Entropy Benchmarking (Linear XEB) was proposed as a tool to estimate the fidelity. The linear XEB (also denoted [symbol] _{XEB}) for a sequence of bit strings, which are called samples s₁, . . . , s_{N}, is defined as follows:

$${ℱ}_{X E B} = {2}^{n} \frac{1}{N} {\sum }_{i = 1}^{N} {p}_{C} ( {s}_{i} ) - 1 .$$

Since the number of amplitudes used in the verification task is very large (˜10⁶ in Google's experiment), and the corresponding bit strings are random, a quite powerful quantum simulator is needed. Given an n-qubit quantum circuit C and a sequence of samples s₁, . . . , s_{N}∈{0, 1}ⁿ, the quantum simulator should find the corresponding N complex amplitudes [symbol] sᵢ|C|0ⁿ [symbol] , i=1, . . . , N.

Sometimes, it may also be required to find N batches of amplitudes instead of N amplitudes, wherein a batch is a set of 2^{m} bit strings B={x∈{0, 1}ⁿ|xᵢ_{₁}=a₁, . . . , xᵢ_{ₙ₋ₘ}=aₙ₋ₘ}, where 1≤i₁< . . . <iₘ≤n, aᵢ∈{0, 1}. Hence, in a batch, n-m components are fixed, and the remaining m components can be arbitrary binary values. Each batch can be described by a so-called mask of length n over the alphabet {0,1,x}, where 0s or 1s are placed in the fixed n-m positions, and x is placed in the remaining m free positions. For example, 01x0x corresponds to the batch B={01000, 01001, 01100, 01101}.

For instance, amplitudes for N random batches of size 64 may have to be found, and from each batch B one bit string s∈B may have to be sampled according to the obtained 64 probabilities p_{C}(s), s∈B.

In summary, there is a need for a powerful quantum simulator capable to perform the mentioned tasks. In particular, a quantum simulator is needed that is able to simulate and/or verify quantum circuits run on large quantum systems.

### SUMMARY

The present disclosure and its embodiments are based further on the following considerations made by the inventors.

Tensor networks are an important tool for simulating large quantum systems, i.e., such networks of tensors may be used by a processor of a quantum simulator to perform simulation and/or verification of a quantum circuit. A tensor networks can represent a quantum circuit (see e.g. FIG. 9), and can thus be used to simulate and/or verify the quantum circuit.

Tensors are multidimensional arrays Aᵢ_{₁}_{, . . . , i}_{ₙ} that can also be viewed as multivariable functions A(i₁, . . . , iₙ), where the variables i₁, . . . , iₙ are also called “indices” or “tensor legs”, and the number n is usually called the “rank” or “degree” of A. The range of each tensor leg as a variable is a finite set, a size of which is usually called the “bond dimension”. Hence, vectors can be considered to be degree 1 tensors and matrices to be degree 2 tensors. The shape of the tensor A is the vector (d₁, . . . , dₙ), where dᵢ is the bond dimension of the ith tensor leg.

Moreover, a tensor network can be represented as a graph (see FIG. 2a), wherein the tensors are assigned to vertices 202, tensor legs (i.e. indices) are assigned to the edges 203, and tensors are connected by an edge 203 if they share a common tensor leg.

Tensor networks are usually used as graphical representations of sums involving several tensors. For example, the tensor network shown in FIG. 2a represents the following sum:

Σ_{i,j,k,l,m}T_{i,j}S_{i,k}U_{j,k,m}Q_{m,l}R_{l,f}.

Notably, this sum depends on the index ƒ, which was not involved in the summation. This is because, by definition, in tensor networks sums are found only over the tensor legs that connect two tensors. All the other tensor legs are not involved in the sum, and can be referred to as “open legs”. In a more general case, it is possible to arbitrarily choose the open tensor legs not necessary connected to only one tensor. Moreover, sometimes tensor legs can be connected to more than two tensors, in which case they may be represented by so-called hyper-edges instead of the edges 203.

This present disclosure can be well applied to this more general case without any significant modification. However, for brevity of description, the present disclosure assumes in the following that all tensor legs are connected to no more than two tensors, and that the tensor legs are connected to only one tensor are open. The sum that corresponds to a tensor network [symbol] is called the “result of its contraction”, and is denoted by Σ [symbol] . The result Σ [symbol] is a tensor, of which the tensor legs are the open legs in the tensor network [symbol] .

In order to optimize the memory used by the contraction, some tensor legs can be fixed in the tensor network (this is usually also called “slicing” or “variable projection”). In this way, it is required to find the contraction for all possible values of the fixed tensor legs (this can be done in parallel) and then to sum up all the results (see FIG. 2b).

Hence, in a tensor network, several tensor legs may be fixed to reduce the maximum size of intermediate tensors during the contraction of the tensor network, such that all intermediate tensors are placed in the memory of the device, on which the contraction is performed.

In the end, the result of the entire network contraction is obtained.

However, the approach has an issue. Usually, the overall complexity of the contraction increases. However, with good optimization, the loss in complexity is not that big.

If there are two tensors Tᵢ_{₁}_{, . . . , i}_{ₙ} and Sⱼ_{₁}_{, . . . , j}_{ₘ} in a tensor network [symbol] and their common non-open tensor legs are precisely k₁, . . . , k_{q}, then their convolution denoted by [symbol] S can be found as follows:

$$T {*}_{𝒩} S = {\sum }_{{k}_{1} , … , {k}_{q}} {T}_{{i}_{1} , … , {i}_{n}} {S}_{{j}_{1} , … , {j}_{m}}$$

The index [symbol] is usually omitted, if the tensor network is clear from the context, and the convolution may thus be simply denoted as T*S. The computational cost C of the convolution operation is easy to estimate. It involves d^{q·r} multiplications and almost the same number of additions, where d is the bond dimension of tensor legs (for simplicity it may be assumed that all bond dimensions are equal) and r is the number of open tensor legs in the result T*S. Indeed, it is possible to sum up d^{q} terms and to do it for all possible d^{r} values of r open legs. In fact, on modern processors, the operation fma(a, b, c)=a+b*c usually has the same complexity as the multiplication b*c, so that the total complexity of the convolution can be calculated as d^{q·r} operations. The number of memory operations RW is also an important parameter, since sometimes the required read/write operations are the bottleneck of the algorithm. As an estimate of the memory operations, it may be supposed that all operations consist only in reading the tensors T, S, and writing the result T*S. Thus, the number of such operations may be estimated as having size(T)+size(S)+size(T*S), wherein size(X) is the size of the tensor X, i.e., the product of all bond dimensions of its tensor legs.

In terms of tensor networks, the convolution of two tensors corresponds to a merging of corresponding vertices in the tensor network (see FIG. 3a, where the vertices of tensors T and S are merged into a vertex T*S).

It can be determined that the convolution operation T*S (as a binary operation on tensors) satisfies the following associativity and commutativity conditions:

T*(S*R)=(T*S)*R (associativity)

T*S=S*T (commutativity)

Hence the result of the convolution for several tensors T₁, . . . , Tₙ does not depend on the way in which the tensors are ordered and in which parentheses are used, and can be denoted as T₁* . . . *Tₙ.

It is also not hard to see that the result of the tensor contraction Σ [symbol] can be obtained, if the convolution operation is sequentially applied in some order to all the tensors involved in the tensor network [symbol] . For example, for the tensor network shown in FIG. 2a, the following convolution expression may be used. A convolution expression is a contraction expression in this disclosure:

Σ [symbol] =(T*U)*S)*(R*Q) (1)

Notably, the same result can be obtained by any other contraction expression that calculates ΣN, for example (Q*T)*(S*U)*R. However, from a practical point of view, a different contraction expression usually has a different computational cost, which is usually measured in the number of arithmetic floating point operations, such as addition and multiplication (FLOPs), and the number of tensor elements that are read and written. Different convolution expressions also have different memory budgets. The memory budget can be estimated by the maximal size of intermediate results (i.e. the size of intermediate convolutions) during the contraction of the convolution expression.

Each contraction expression can be naturally represented by a binary tree that is usually called the convolution tree. A convolution tree is a contraction tree in this disclosure. In this contraction tree, the leaves correspond to tensors and internal nodes correspond to the convolutions. For example, the contraction tree shown in FIG. 3b corresponds to the convolution expression (1).

If [symbol] is a contraction tree for a tensor network with tensors T₁, . . . , Tₙ, then the result of the corresponding contraction expression (i.e. the result of the contraction Σ [symbol] ) is denoted by [symbol] (T₁, . . . , Tₙ).

In view of the above, a general aspect of the present disclosure is to provide a processor for a quantum simulator that is able to simulate and/or verify quantum circuits run on large quantum systems. A particular aspect is to provide a processor, which is able to perform a tensor network contraction operation that finds a good contraction expression (and accordingly contraction trees) for one or more tensor networks. This operation can then be used in the simulation and/or verification of a quantum circuit. In particular, a goal is to keep the following characteristics as small as possible when finding the contraction expression and contraction tree [symbol] (notably, when these characteristics are taken into account, the resulting contraction expressions is considered “good”):
The amount of memory M=M( [symbol] ) required, including the cache size and memory for intermediate contraction results.
Computational complexity C=C( [symbol] ), i.e., the number of floating-point operations (Flops), calculated as the sum of the complexity over all convolutions in the contraction tree [symbol] .
The parameter RW=RW ( [symbol] ) which is equal to the number of read-write operations from the memory for all convolutions in the contraction tree [symbol] .

These and other aspects are achieved by the embodiments of this disclosure as described in the enclosed independent claims. Advantageous implementations of the embodiments are further defined in the dependent claims.

A first aspect of this disclosure provides a processor for a quantum simulator, wherein the processor is configured to: perform a local search algorithm to determine a plurality of contraction expressions, wherein each contraction expression is suitable to contract a respective tensor network of one or more tensor networks into a determined contracted tensor network; determine, for each contraction expression, a contraction cost for contracting the respective tensor network into the determined contracted tensor network based on a cost function; select the contraction expression with the lowest contraction cost; and contract each tensor network of the one or more tensor networks into the determined contracted tensor network; wherein the cost function is based on at least: a first parameter indicating an amount of memory required for contracting the respective tensor network into the determined contracted tensor network; a second parameter indicating a computational complexity required for contracting the respective tensor network into the determined contracted tensor network based on the selected contraction expression; and a third parameter indicating a number of read-write operations required for contracting the respective tensor network into the determined contracted tensor network.

As mentioned above, a contraction expression may be a convolution expression. Further, a contraction expression corresponds to a contraction tree, which thus may be a convolution tree.

The processor of the first aspect is able to find a (good) contraction expressions and accordingly contraction tree for contracting the one or more tensor networks into the determined contracted tensor network, i.e., a contracted tensor network having a determined shape or structure. In particular, the processor may find a contraction expression that keeps the above-mentioned three characteristics as small as possible. Since the processor is configured to contract also multiple tensor networks (e.g., in parallel when they are of the same shape), it is suitable for MA quantum simulation. Thus, an improved quantum simulator, in particular, a MA quantum simulator, may be provided based on the processor of the first aspect, wherein the quantum simulator is able to simulate and/or verify quantum circuits run on a large quantum system.

In an implementation form of the first aspect, the one or more tensor networks have the same graph representation.

The processor of the first aspect can efficiently find the extraction expression for the multiple tensor networks (in particular, it finds a contraction expression/contraction tree of the same shape or structure for each of the multiple tensor networks).

In an implementation form of the first aspect, the cost function is based on an arithmetic intensity, which is defined by a ratio of the second parameter and the third parameter.

Taking into account the arithmetic intensity may lead to the best overall performance of the tensor network contraction operation performed by the processor of the first aspect, since this takes into account that the memory speed and the computation speed on a particular hardware are not the same.

As mentioned, it is defined as the ratio of computational complexity (the number of elementary floating point operations) to the number of memory read/write operations during the tensor contraction. The arithmetic intensity parameter cannot not be less than the ratio of the computation speed (Flops, the number of operations with floating point per second) to the maximum speed of the device memory (B/s). For example, in GPU Tesla V100 this value is approximately equal to 16. Hence the arithmetic intensity is a device dependent parameter, which may be different for different hardware.

In an implementation form of the first aspect, the cost function ƒ( [symbol] ) is determined by:

$$f ( 𝒯 ) := βmax ( {log}_{2} ( \frac{M}{{M}_{max}} ) , 0 ) + {log}_{2} ( C + α \cdot RW )$$

wherein M is the first parameter, C is the second parameter, RW is the third parameter, Mₘₐₓ is an upper memory amount limit, α is the arithmetic intensity, and β is a penalty factor for controlling the weight of the first parameter.

In particular, the penalty factor β controls the weight of the memory size in the cost function. If the memory budget is more important, the value of β may be increased.

In an implementation form of the first aspect, performing the local search algorithm to determine the plurality of contraction expressions comprises applying a plurality of local transformations, the plurality of local transformations including at least one of the following local transformations from a first contraction expression to a second contraction expression:

from (a*b)*c to (c*b)*a;

from (a*b)*c to (a*c)*b;

from a*(b*c) to b*(a*c);

from a*(b*c) to c*(b*a);

wherein a, b, and c are tensors of the respective tensor network and, * denotes a convolution operation.

In an implementation form of the first aspect, the local search algorithm comprises a hill climbing algorithm or a simulated annealing algorithm.

In an implementation form of the first aspect, the respective tensor network has a graph representation comprising a vertex for each tensor of the respective tensor network and at least one edge for each tensor leg of each tensor, and the processor is further configured to perform a slicing operation during the local search algorithm by fixing a set of tensor legs in the respective tensor network.

Thus, the above-described advantages of slicing during performing the tensor network contraction operation may be achieved.

In an implementation form of the first aspect, the processor is configured to update the fixed set of tensor legs after a determined number of steps of performing the local search algorithm by removing a random tensor leg from the fixed set and/or adding a tensor leg resulting in the largest reduction of the first parameter to the fixed set.

Thus, the first parameter may advantageously be reduced, i.e., may ideally be minimized for the lowest memory requirements.

In an implementation form of the first aspect, the processor is further configured to select the same contraction expression with the lowest contraction cost for contracting in parallel each of multiple tensor networks having the same graph representation into the determined contracted tensor network.

Thus, the processor is suitable for a MA quantum simulator, i.e., for finding multiple amplitudes or batches of amplitudes in parallel.

In an implementation form of the first aspect, each contraction expression comprises at least one convolution of two tensors of the respective tensor network of the one or more tensor networks; and/or determining a contraction cost of a contraction expression comprises performing at least one convolution of two tensors of the respective tensor network of the one or more tensor networks.

That is, the contraction expression is a convolution expression. Due to the above-described characteristics of the convolution expression, an efficient tensor network contraction operation based on a local search algorithm can be performed.

In an implementation form of the first aspect, the processor is configured to save a convolution result of determining a convolution of two tensors of the respective tensor network in a cache.

In an implementation form of the first aspect, the processor is configured to reuse a convolution result, which was saved while contracting a first tensor network, when contracting a second tensor network.

Thus, a computational speed of processing (contracting) multiple tensor networks in parallel can be increased.

A second aspect of this disclosure provides a quantum simulator for simulating a quantum circuit, wherein the quantum simulator comprises a processor according to the first aspect or any of its implementation forms.

In an implementation form of the second aspect, the quantum simulator is configured to simulate a quantum circuit, wherein simulating the quantum circuit comprises contracting one or more tensor networks into the determined contracted tensor network.

In an implementation form of the second aspect, the quantum simulator is configured to perform a verification of a quantum circuit by finding an amplitude of each of multiple samples produced by the quantum circuit.

In an implementation form of the first aspect, the quantum simulator is configured to determine a linear cross-entropy benchmarking of a bit string including a plurality of samples produced by a quantum circuit.

A third aspect of this disclosure provides a processing method for a quantum simulator, wherein the method comprises: performing a local search algorithm to determine a plurality of contraction expressions, wherein each contraction expression is suitable to contract a respective tensor network of one or more tensor networks into a determined contracted tensor network; determining, for each contraction expression, a contraction cost for contracting the respective tensor network into the determined contracted tensor network based on a cost function; selecting the contraction expression with the lowest contraction cost; and contracting each tensor network of the one or more tensor networks into the determined contracted tensor network; wherein the cost function is based on at least: a first parameter indicating an amount of memory required for contracting the respective tensor network into the determined contracted tensor network based on the selected contraction expression; a second parameter indicating a computational complexity required for contracting the respective tensor network into the determined contracted tensor network; and a third parameter indicating a number of read-write operations required for contracting the respective tensor network into the determined contracted tensor network.

In an implementation form of the third aspect, the one or more tensor networks have the same graph representation.

In an implementation form of the third aspect, the cost function is based on an arithmetic intensity, which is defined by a ratio of the second parameter and the third parameter.

In an implementation form of the third aspect, the cost function ƒ( [symbol] ) is determined by:

$$f ( 𝒯 ) := βmax ( {log}_{2} ( \frac{M}{{M}_{max}} ) , 0 ) + {log}_{2} ( C + α \cdot RW )$$

wherein M is the first parameter, C is the second parameter, RW is the third parameter, Mₘₐₓ is an upper memory amount limit, α is the arithmetic intensity, and β is a penalty factor for controlling the weight of the first parameter.

In an implementation form of the third aspect, performing the local search algorithm to determine the plurality of contraction expressions comprises applying a plurality of local transformations, the plurality of local transformations including at least one of the following local transformations from a first contraction expression to a second contraction expression:

from (a*b)*c to (c*b)*a;

from (a*b)*c to (a*c)*b;

from a*(b*c) to b*(a*c);

from a*(b*c) to c*(b*a);

wherein a, b, and c are tensors of the respective tensor network and, * denotes a convolution operation.

In an implementation form of the third aspect, the local search algorithm comprises a hill climbing algorithm or a simulated annealing algorithm.

In an implementation form of the third aspect, the respective tensor network has a graph representation comprising a vertex for each tensor of the respective tensor network and at least one edge for each tensor leg of each tensor, and the method further comprises performing a slicing operation during the local search algorithm by fixing a set of tensor legs in the respective tensor network.

In an implementation form of the third aspect, the method comprises updating the fixed set of tensor legs after a determined number of steps of performing the local search algorithm by removing a random tensor leg from the fixed set and/or adding a tensor leg resulting in the largest reduction of the first parameter to the fixed set.

In an implementation form of the third aspect, the method comprises selecting the same contraction expression with the lowest contraction cost for contracting in parallel each of multiple tensor networks having the same graph representation into the determined contracted tensor network.

In an implementation form of the third aspect, each contraction expression comprises at least one convolution of two tensors of the respective tensor network of the one or more tensor networks; and/or determining a contraction cost of a contraction expression comprises performing at least one convolution of two tensors of the respective tensor network of the one or more tensor networks.

In an implementation form of the third aspect, the method comprises saving a convolution result of determining a convolution of two tensors of the respective tensor network in a cache.

In an implementation form of the third aspect, the method comprises reusing a convolution result, which was saved while contracting a first tensor network, when contracting a second tensor network.

The method of the third aspect and its implementation forms achieve the same advantages and effects as the device of the first aspect and its respective implementation forms.

A fourth aspect of this disclosure provides computer program comprising a code, wherein when the code is executed by a processor, the processor is caused to perform the method according to the third aspect or any of its implementation forms.

A fifth aspect of the present disclosure provides a non-transitory storage medium storing executable program code which, when executed by a processor, causes the method according to the third aspect or any of its implementation forms to be performed.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 illustrates a simulation of a random quantum circuit run on a quantum system (Google's Sycamore 53 qubits chip).

FIG. 2a shows an example of a tensor network with open tensor legs.

FIG. 2b illustrates slicing during tensor network contradiction.

FIG. 3a illustrates a convolution operation of two tensors.

FIG. 3b illustrates an exemplary contraction tree of the tensor network of FIG. 2b.

FIG. 4 shows a processor according to an embodiment of this disclosure.

FIG. 5 illustrates a tensor network, a contraction expression for the tensor network, and a corresponding contraction tree for the tensor network.

FIG. 6 illustrates multiple tensor networks of the same graph representation, shape-identical contraction expressions found for the tensor networks, and shape-identical corresponding contraction trees for the tensor network.

FIG. 7a illustrates local transformations used in a local search algorithm in terms of contraction trees.

FIG. 7b illustrates an example of possible steps of a local search algorithm.

FIG. 8a shows a tensor network and a corresponding tensor network diagram.

FIG. 8b shows an exemplary contraction tree.

FIG. 8c shows subsequently obtained exemplary contraction trees.

FIG. 9a shows an exemplary quantum circuit.

FIG. 9b shows an exemplary tensor network diagram for the exemplary quantum circuit of FIG. 9a.

FIG. 10 shows an exemplary contraction tree in detail.

FIG. 11 shows results of single-amplitude vs. multi-amplitude simulations.

FIG. 12 shows a quantum simulator according to an embodiment of this disclosure.

FIG. 13 shows a method for a quantum simulator according to an embodiment of this disclosure.

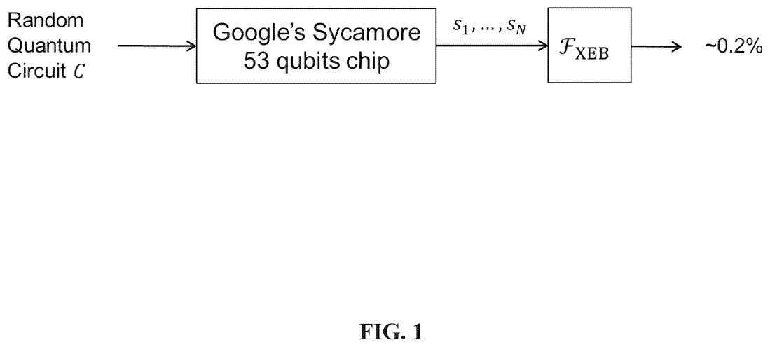

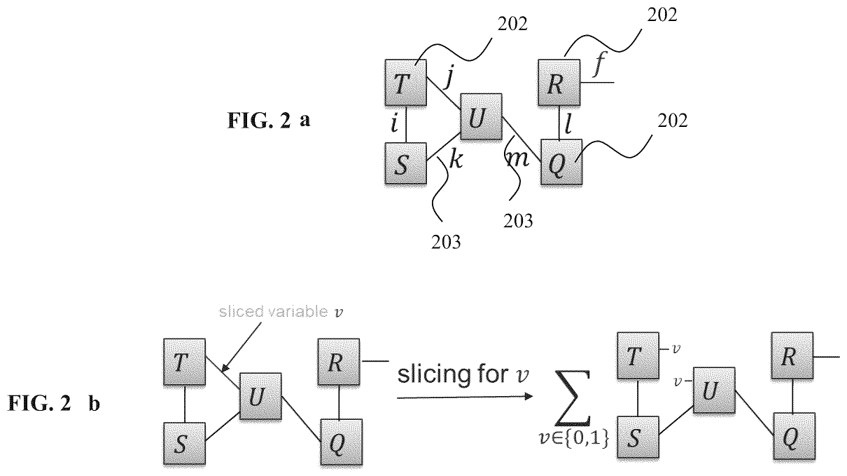

### DETAILED DESCRIPTION OF EMBODIMENTS

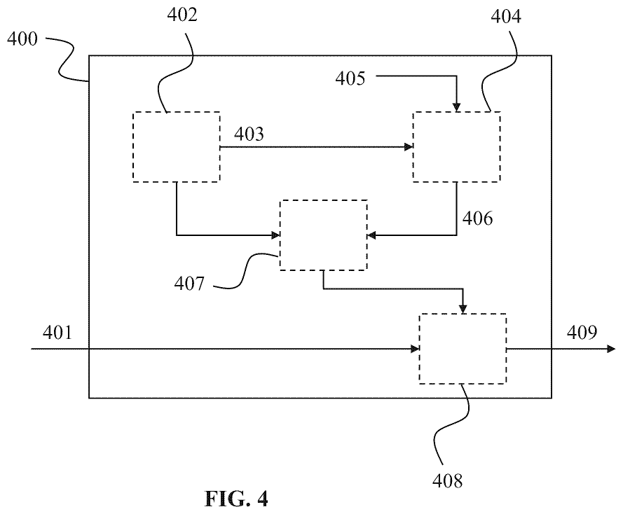

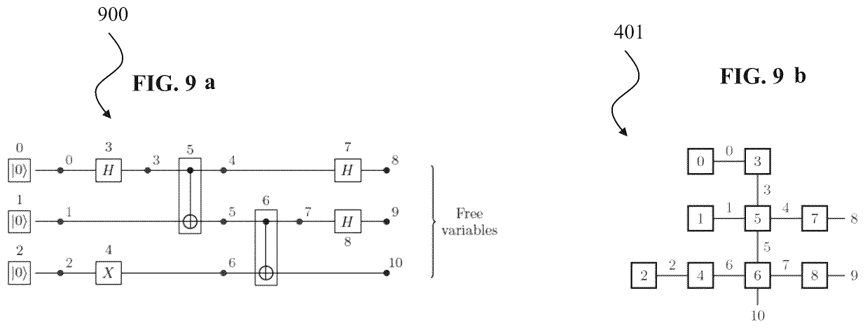

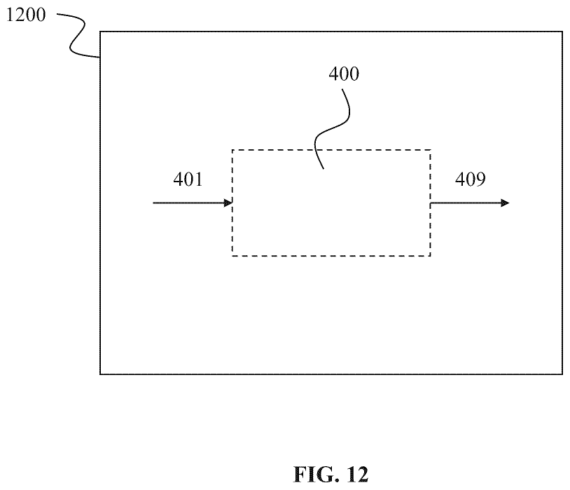

FIG. 4 shows a processor 400 according to an embodiment of this disclosure. The processor 400 is configured to be use in a quantum simulator (see, e.g., the quantum simulator 1200 shown in FIG. 12). The processor 400 may specifically be configured to perform a contraction of one or more tensor networks 401. Thereby, the one or more tensor networks 401 may all have the same graph representation (i.e., they may have the same shape or structure). The quantum simulator may use the processor 400 to simulate and/or verify one or more quantum circuits (see, e.g., the exemplary quantum circuit 900 shown in FIG. 9).

The processor 400 is configured to perform a local search algorithm 402, e.g. a hill climbing algorithm or a simulated annealing algorithm, in order to determine a plurality of contraction expressions 403, for instance, convolution expressions. Each of the contraction expressions 403 is suitable to contract a respective tensor network 401 of the one or more tensor networks 401 into a determined contracted tensor network 409. The determined contracted tensor network 409 may be a pre-determined target contracted tensor network. Each contraction expression 403 is such that it can contract any one of the tensor networks into the determined contracted tensor network 409, i.e., into a contracted tensor network having a certain shape or form or configuration.

The processor 400 is further configured to determine (e.g., at the optional block 404), for each contraction expression 403, a contraction cost 406, wherein the contraction cost 406 is a cost needed for contracting the respective tensor network 401 into the determined contracted tensor network 409. The contraction cost 406 is determined based on a cost function 405. The cost function 405 is based on at least the following three parameters. A first parameter, which indicates an amount of memory required for contracting the respective tensor network 401 into the determined contracted tensor network 409. A second parameter, which indicates a computational complexity required for contracting the respective tensor network 401 into the determined contracted tensor network 409. A third parameter, which indicates a number of read-write operations required for contracting the respective tensor network 401 into the determined contracted tensor network 409.

The processor 400 is further configured to select (e.g., at the optional block 407) the contraction expression 403 with the lowest contraction cost 406, and to contract 408 each tensor network 401 of the one or more tensor networks 401 into the determined contracted tensor network 409 based on the selected contraction expression 403. That is, it may use the selected contraction expression 403 to contract each one of the tensor networks 401. The “selected contraction expression” thereby has the same form or shape for each tensor network. Of course, different tensors of the tensor networks are also reflected as different tensors in the contraction expression, as it is used to contract the respective tensor networks 401.

The processor 400 may comprise hardware (processing circuitry) and/or may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The processor 400 may further comprise memory circuitry, which stores one or more instruction(s) that can be executed by the processing circuitry, in particular under control of the software. For instance, the memory circuitry may comprise a non-transitory storage medium storing executable software code which, when executed by the processing circuitry, causes the various operations of the processor 400 to be performed.

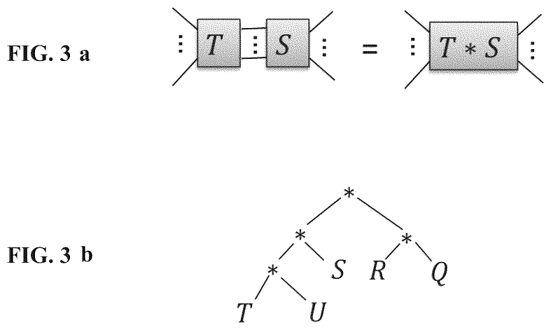

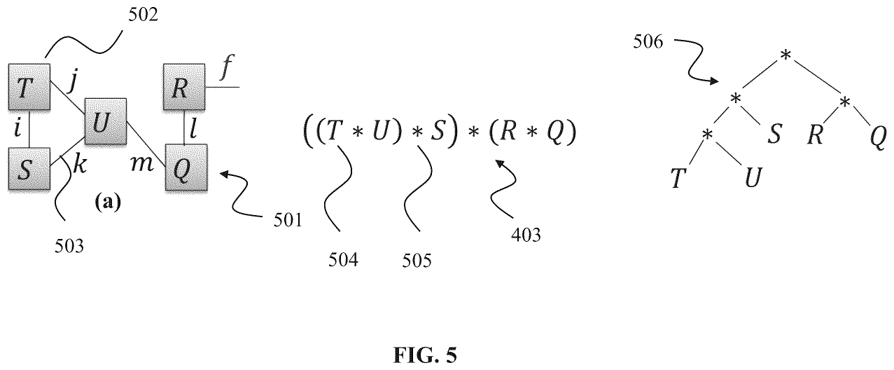

FIG. 5 illustrates a single-amplitude (SA) tensor network contraction operation, which can be performed by the processor 400. In particular, an exemplary respective tensor network 401 is illustrated, which has a certain graph representation 501. The graph representation 501 comprises a vertex 502 for each tensor 504 of the respective tensor network 401, and at least one edge 503 for each tensor leg of each tensor 504. The processor 400 is configured to find, and then select, a “good” contraction expression 403 as described above. The contraction expression 403 may comprise at least one convolution 505 of two tensors 504 of the respective tensor network 401. Determining the contraction cost 406 of the contraction expression 403 may comprise performing the at least one convolution 505 of the two tensors 504. The convolutions 505 may be defined as described above with respect to FIG. 3a. The contraction expression 403 may be represented by the corresponding contraction tree 506.

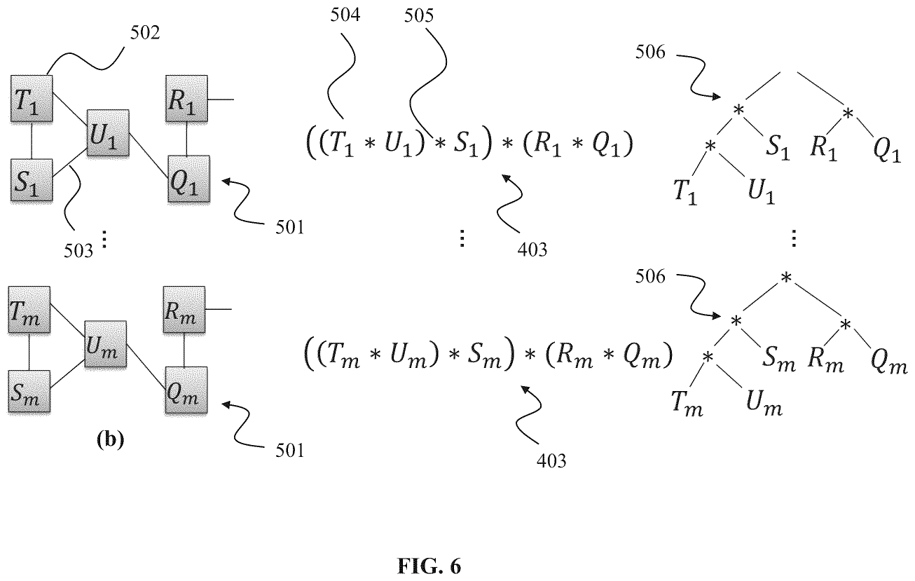

FIG. 6 illustrates a (MA) tensor network contraction operation, which can be performed by the processor 400. For the MA tensor network contraction operation, m tensor networks 401 with the same graph representation 501 (i.e., the same shape and/or same tensor diagram or the same structure), but with different specific tensors 504, may be contracted. The processor 400 is configured to select the same contraction expression 403 (i.e. the same shape or structure of the contraction expression, but of course having different tensors 504 reflecting respectively the specific tensors 504 of the different tensor networks 401) with the lowest contraction cost 406 when contracting in parallel each of the tensor networks 401 into the determined contracted tensor network 409. The contraction expression 403 leads to the same corresponding contraction tree(s) 506 (same shape or structure, but with different specific tensors 504) for each tensor network 401.

More details regarding the embodiments of this disclosure, particularly the processor 400 and quantum simulator 1200, are described in the following.

In order to find a close to optimal contraction tree 506 (and thus a “good” contraction expression 503), any local search algorithm 402, such as hill climbing or simulated annealing, can be used together with the cost function 405 (which is also referred to as “objective function ƒ( [symbol] )” in this disclosure). A local search algorithm 402 is a combinatorial optimization method that given an objective function ƒ:X→ [symbol] on the search space X of all possible states try to apply a small fixed number of local transformations L={l₁, . . . , lₙ} (each transformation lᵢ is a function lᵢ:X→X) starting usually from some random or predefined state x₀∈X. Hence, a sequence of states x₀, x₁, . . . , x_{N} is obtained, wherein each next state xᵢ₊₁ is obtained from the previous state xᵢ using one of the local transformations from the set L, i.e. xᵢ₊₁=l(xᵢ) for some l∈L.

The choice of the local transformation l∈L on each step is usually governed by the gain

Δƒ(xᵢ, l):=ƒ(l(xᵢ))−ƒ(xᵢ)

that is obtained in terms of the objective (cost) function ƒ. The local search algorithm 402 usually stops when it reaches a state x_{N} that cannot be improved locally (i.e., Δƒ(xᵢ, l)<0 for all l∈L) or the maximal number of steps is reached. There are many other details on how a local search algorithm 402 can be done. For example, in the simulated annealing algorithm, local transformations can be chosen randomly with a probability that depends on the gain Δƒ(xᵢ, l). At the same time, in the hill climbing algorithm, a local transformation can be chosen deterministically in a greedy fashion (i.e., the local transformation which gives the best possible gain may be chosen). However, in this disclosure, only the objective function 406 and the local transformations are described. Hence, embodiments of this disclosure may be used with any local search algorithm 402 like hill climbing or simulated annealing.

It was shown above that the convolution operation T*S for two or more tensors 504 satisfies the associativity and commutativity conditions. Using these two conditions, the following identities can be deduced. These may be used as local transformations in the local search algorithm 402:

(a*b)*c→(c*b)*a

(a*b)*c→(a*c)*b

a*(b*c)→b*(a*c)

a*(b*c)→c*(b*a)

Therein, a first contraction expression 403 (left side) is locally transformed (→) into a second contraction expression 403 (right side). Accordingly, performing the local search algorithm 402 (by the processor 400) comprises applying a plurality of local transformations, the plurality of local transformations including at least one of the above local transformations, wherein a, b, and c are tensors 504 of the respective tensor network 401 and, * denotes a convolution operation.

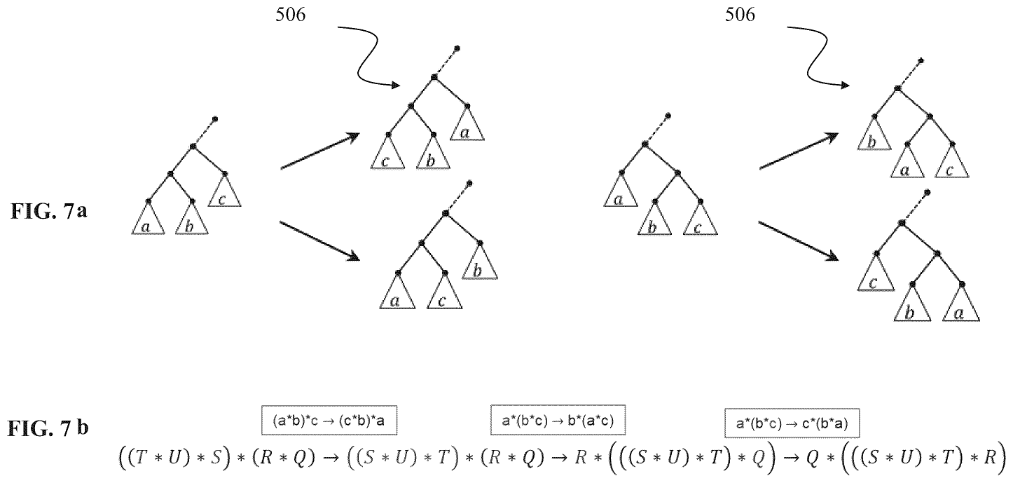

FIG. 7a shows these four local transformation in terms of contraction trees 506 (wherein the triangles corresponds to subtrees of the contraction trees 506). The set of states in the local search (contraction tree optimization) algorithm 502 is the set of all possible contraction trees 506 for a tensor network [symbol] , which may also be interpreted as convolution expressions 403 used to find the result of the contraction Σ [symbol] . It may be supposed that on each step of the local search algorithm 402, one of these four local transformations can be applied to any subexpression (i.e. to a subtree [symbol] ′ of the contraction tree [symbol] ). FIG. 7b shows an example of some possible steps of the local search algorithm 402.

Notably, it is also possible to add to the list of the local transformation some additional operations related to slicing. As it was described above, slicing (also called “variable projection”) may be used to reduce the memory budget at the price of some moderate increase of the computational complexity. That is, the processor 400 may be further configured to perform a slicing operation during performing the local search algorithm 402, in particular, by fixing a set of tensor legs 503 in the respective tensor network 401.

The following slight modification to the above local search algorithm 402 is thus proposed in an embodiment of this disclosure. Every K steps of the local search algorithm 402, the list S of legs used for slicing may be updated. With a probability of ½, one of the following two additional steps may be performed: add to the list S the leg that results in the best memory budget M reduction; remove the random leg from S. That means, after a determined number of steps of performing the local search algorithm 402, the fixed set of tensor legs may be updated by the processor 400 by removing a random tensor leg from the fixed set and/or adding a tensor leg resulting in the largest reduction of the first parameter (indicating memory budget) to the fixed set. If K is quite big (e.g., K=10⁵), then we apply these two additional steps are not performed very often, and the overall running time of our local search method is almost unchanged with this small modification.

Both the computational complexity and the memory budget do not depend on the content of the tensors 502 in a contraction tree 506. In fact, they only depend on the shapes of the tensors T₁, . . . , Tₙ. Thus, it is helpful to consider formal expressions, where instead of some fixed tensors in the convolution expression 403, there are variables X₁, . . . , Xₙ that denote arbitrary tensors 504 of the same shapes as the tensors T₁, . . . , Tₙ. Every convolution tree [symbol] with n leaves may be considered also as a formal convolution expression [symbol] (X₁, . . . , Xₙ). Hence, it can be seen that the contraction tree [symbol] is just a pictorial way to represent a formal convolution expression [symbol] (X₁, . . . , Xₙ). Moreover, it can be seen that the subtrees [symbol] ′ of the contraction tree [symbol] for a convolution expression [symbol] (X₁, . . . , Xₙ) represent its subexpressions [symbol] ′(Xᵢ_{₁}, . . . , Xᵢ_{ₛ}). Hence, in what follows, formal contraction expressions 403 and the corresponding contraction trees are identified.

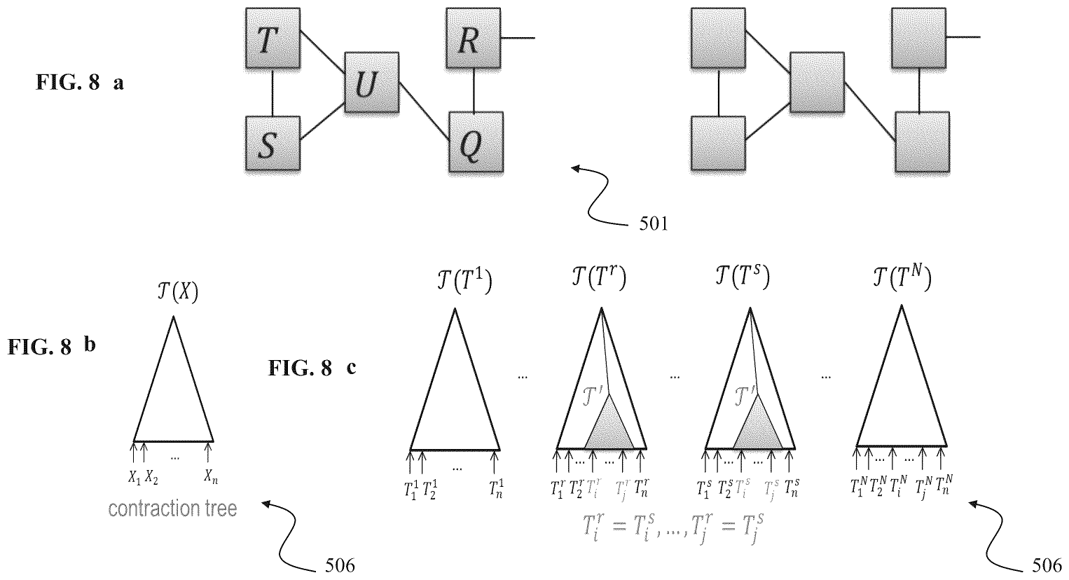

As shown in FIG. 8a, a tensor network diagram (a graph representation 501 of a tensor network 401) is just a tensor network D, where instead of fixed tensors T₁, . . . , Tₙ of some shapes, there are variables X₁, . . . , Xₙ that correspond to arbitrary tensors of the same shapes. In order to emphasize its variables, a tensor network diagram may be denoted as D(X₁, . . . , Xₙ). If assigning tensors T₁, . . . , Tₙ to the variables X₁, . . . , Xₙ the tensor network that is denoted by D(T₁, . . . , Tₙ) may be obtained. The result of the contraction for this tensor network is denoted as ΣD(T₁, . . . , Tₙ).

In a MA (resp. multi-batch) quantum simulator, usually N different amplitudes (resp. batches) are to be found. One simple way to do this is just to run a single-amplitude or single-batch contraction algorithm N times. However, this simple method is not very efficient in the case when we need to find a large number (say ˜10⁶) of amplitudes or batches. In the following is described how to do this in a much more efficient way using the processor 400.

Given an exemplary quantum circuit C, it can be converted into a tensor network [symbol] _{C} in a standard way. This tensor network [symbol] _{C} has s open legs, where s is the number of qubits in the exemplary quantum circuit (each open leg corresponds to one output qubit). Let further D=D(X) , X=(X₁, . . . , Xₙ) be the tensor network diagram for [symbol] _{C} with tensor variables X₁, . . . , Xₙ. As it was already mentioned before, in a MA simulator, it is needed to find N complex amplitudes [symbol] sᵢ|C|0ⁿ [symbol] for N bit strings s₁, . . . , s_{N}∈{0, 1}ⁿ. This can be obtained as the result of the contractions of N tensor networks D(T¹), . . . , D(T^{N}), wherein each collection of tensors Tⁱ=(T₁ⁱ, . . . , Tₙⁱ), i=1̅,̅ N̅, corresponds to one bit string sᵢ (assigned the output legs of [symbol] _{C}). Given a certain contraction tree [symbol] (X)= [symbol] (X₁, . . . , Xₙ) (for example, found by the described earlier local search algorithm 402), it can be used to perform the contractions for the N tensor networks D(T¹), . . . , D(T^{N}) and to obtain: [symbol] sᵢ|C|0ⁿ [symbol] =ΣD(Tⁱ)= [symbol] (Tⁱ), i=1̅,̅ N̅, Hence it can be seen that the MA contraction is equivalent to the following task. Let D be the tensor network diagram and [symbol] (X) is the corresponding contraction tree (see FIG. 8b) given by some contraction expression (e.g., [symbol] (X)=((X₁*X₂)*X₃)*(X₄*X₅))).

The goal is to find [symbol] (T¹), . . . , [symbol] (Tⁿ) for multiple collections of tensors Tⁱ=(T₁ⁱ, . . . , Tₙⁱ), i=1, . . . , N. A key observation is that if one performs these N contractions sequentially for i=1,2, . . . , N and if some subexpression [symbol] ′(Xᵢ_{₁}, . . . , Xᵢ_{ₛ}) of [symbol] (X) are already contracted, then the results can be reused in the next contractions in the cases when the values of variables Xᵢ_{₁}, . . . , xᵢ_{ₛ} are the same (see FIG. 8c). In other words, the processor 400 may be configured to reuse a convolution result, which was saved while contracting a first tensor network, when contracting a second tensor network.

Hence, a recursive algorithm for calculating these N contractions can be considered (it may be referred to as multi-tensor contraction procedure since it produces N tensors) that stores the intermediate results of all its recursive calls in some global cache K. It may be assumed that K can be updated during the algorithm work. This cache K can be implemented as a key lookup data structure, where keys are collections of tensors and the values are the tensors. It is possible to write K(v)=T if for a collection of tensors v there is the entry T. Else, it is possible to write K(v)=null if there is no available entry for the key v. Thus, the following procedure may find [symbol] (T¹), . . . , [symbol] (Tⁿ) for multiple collections of tensors Tⁱ=(T₁ⁱ, . . . , Tₙⁱ), i=1, . . . , N:

K = empty; // start with the empty global cache
for i = 1, ... , N do:
Calculate [symbol] (Tⁱ) := eval( [symbol] , Tⁱ, K);
return [symbol] (T¹), ... , [symbol] (T¹).

It can be seen that in the above procedure, the subprocedure eval( [symbol] , T, K) is called N times, which given the contraction tree [symbol] , a collection of tensors Tⁱ, and the intermediate results of the previous calls gives [symbol] (T), i.e. the result of the evaluation of the expression [symbol] (X) on the collection of tensors T. Below the description of this procedure is provided.

```
Procedure eval( [symbol] , T, K):
  if [symbol]  = Xⱼ then return Tⱼⁱ;
  Let Xᵢ_{₁}, ... , Xᵢ_{ₛ} be the variables of [symbol] ;
  if K(Tᵢ_{₁}, ... , Tᵢ_{ₛ}) = null then
    Let [symbol]  = [symbol] _{L} * [symbol] _{R}, where [symbol] _{L} and [symbol] _{R} are the left and right subtrees
of [symbol] ;
    Calculate the tensors U_{L} := eval( [symbol] _{L}, Tⁱ, K) , U_{R} :=
eval( [symbol] _{R}, Tⁱ, K);
    Calculate U := U_{L} * U_{R}; // perform the convolution operation;
    K(Tᵢ_{₁}, ... , Tᵢ_{ₛ}) := U; // store the result U to the cache K;
  else return K(Tᵢ_{₁}, ... , Tᵢ_{ₛ}) // we already have this value in K.
```

The idea of the above algorithm may be demonstrated on a simple example considering a quantum circuit 900 with 3 qubits and the corresponding tensor diagram (see FIG. 9). In this tensor diagram D(X₀, . . . , X₈), for simplicity, the tensor variables are denoted X₀, . . . , X₈ by the numbers 0-8 and their tensor legs by the numbers 0-7, and the open tensor legs by the numbers 8-10.

If three binary values s₁, s₂, s₃ of the output qubits are fixed (i.e. the values of the open legs 8,9,10 are fixed), then the values T₀, . . . , T₈ of all tensor variables X₀, . . . , X₈ in the diagram D are fixed, and the complex amplitude [symbol] s₁s₂s₃|C|0ⁿ [symbol] for the bit string s₁s₂s₃ is equal to the result of the contraction: ΣD(T₀, . . . , T₈)=ΣD(T), where T=(T₀, . . . , T₈).

The goal is to find the complex amplitudes for the following 3 bit strings: 000, 100, 111. First, some contraction tree may be found (the local search algorithm 402 described above may be used to find such a tree). For example, the following tree [symbol] given by the convolution expression may be used:

[symbol]

(X₀, . . . , X₈)=(((X₀*X₃)*(X₁*X₅))*((X₂*X₄)*(X₆*X₈)))*X₇

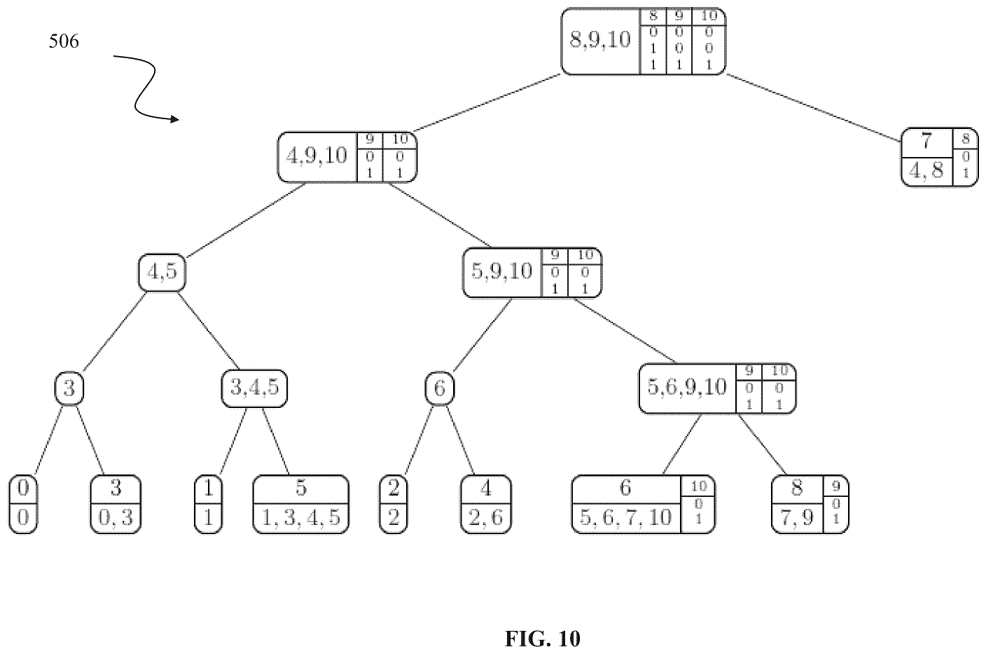

for the quantum circuit C shown in FIG. 9a (FIG. 9b shows the corresponding tensor network 401 (in a diagram representation), for the quantum circuit 900). In order to find our N=3 complex amplitudes [symbol] s₁s₂s₃|C|0ⁿ [symbol] for the bit strings s₁s₂s₃∈{000,100,111} it is necessary to find [symbol] (T¹), [symbol] (T²), and [symbol] (T³), where each vector of tensors Tⁱ=(T₀ⁱ, . . . , T₈ⁱ), i=1, 2, 3, corresponds to our three bit strings 000, 100, 111, respectively. FIG. 10 shows an annotated convolution tree [symbol] , where for each internal tree node that corresponds to a convolution, the legs from 0-7 are shown (it is summed up over them in this convolution) and the open tensor legs from 8-10 are shown (the values of these legs are fixed when the bit string s₁s₂s₃ is fixed).

For the open tensor legs also their possible values are shown. The number of these values shows how many times the contraction has to be performed for this subtree. For example, for the subtree (X₀*X₃)*(X₁*X₅) there are no open legs, hence it needs to be calculated only once when finding [symbol] (T¹), and the result may be reused in [symbol] (T²), and [symbol] (T³). At the same time, for the subtree (X₂*X₄)*(X₆*X₈) there are two possible values (00 and 11) for the open legs 9 and 10, hence, this subtree needs to be contracted twice. However, if 3 times a single-amplitude simulator would be used instead, it would be required to contract each subtree three times.

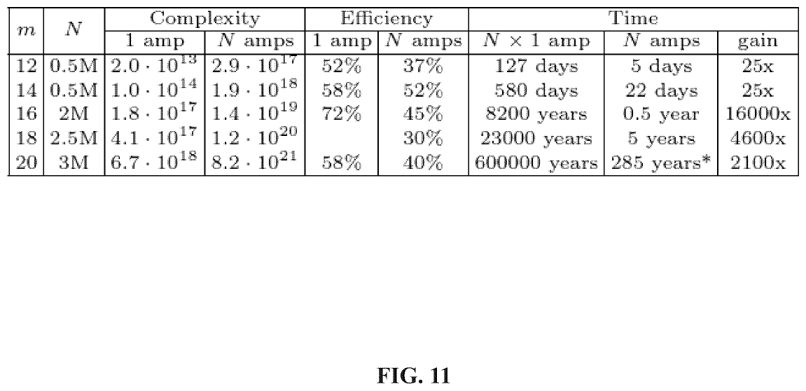

The embodiments proposed in this disclosure, in particular the algorithm performed by the processor 400, can be applied for verification of large random quantum circuits such as used in the recent Google's quantum supremacy experiment. It can also be used in other tasks, where it is needed to find many amplitudes not arranged in batches. FIG. 11 demonstrates the complexity (measured in FLOPs) for N runs of SA simulator and one run of a MA simulator for Google's Sycamore circuits from according to an embodiment of this disclosure. It can be seen that the complexity of the MA simulator is up to several thousand times smaller than for SA one.

FIG. 12 shows a quantum simulator 1200 according to an embodiment of this disclosure. The quantum simulator 1200 may be the MA simulator described above. The quantum simulator comprises a processor 400 as described in this disclosure (see e.g., FIG. 4). The quantum simulator 1200 is configured to simulate a quantum circuit 900, e.g., the one shown in FIG. 9. During the simulation of the quantum circuit 900, the quantum simulator 1200 is configured to use the processor 400 to contract one or more tensor networks 401 as described above. Specifically, the quantum simulator 1200 may use the processor 400 to perform a verification of a quantum circuit 900 according to the above-described MA simulation, i.e., by finding an amplitude of each of multiple samples produced by the quantum circuit 900.

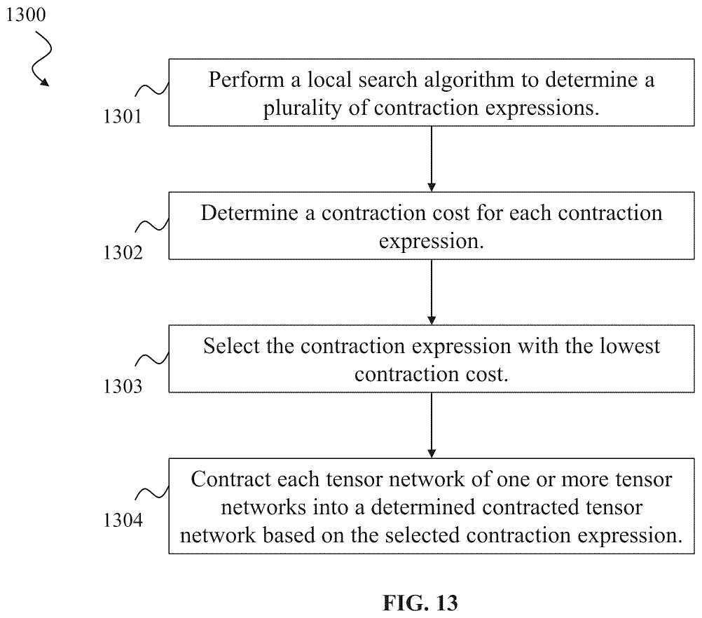

FIG. 13 shows a method 1300 according to an embodiment of this disclosure. The method 1300 may be performed by the processor 400 or by the quantum simulator 1200 using the processor 400.

The method comprises a step 1301 of performing a local search algorithm 402 to determine a plurality of contraction expressions 403. Each contraction expression 403 is suitable to contract a respective tensor network 401 of one or more tensor networks 401 into a determined contracted tensor network 409. Further, the method 1300 comprises a step 1302 of determining, for each contraction expression 403, a contraction cost 406 for contracting the respective tensor network 401 into the determined contracted tensor network 401 based on a cost function 405. The method 1300 then comprises a step 1303 of selecting the contraction expression 403 with the lowest contraction cost 406, and a step 1304 of contracting each tensor network 401 of the one or more tensor networks 401 into the determined contracted tensor network 409 based on the selected contraction expression 403. The cost function 405 used in step 1302 is based on at least: a first parameter indicating an amount of memory required for contracting 1304 the respective tensor network 401 into the determined contracted tensor network 409; a second parameter indicating a computational complexity required for contracting 1304 the respective tensor network 401 into the determined contracted tensor network 409; and a third parameter indicating a number of read-write operations required for contracting 1304 the respective tensor network 401 into the determined contracted tensor network 409.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A non-transitory memory storing instructions and a processor for a quantum simulator, wherein when the processor executes the instructions, the processor is configured to:
perform a local search algorithm to determine a plurality of contraction expressions, wherein each contraction expression is suitable to contract a respective tensor network of one or more tensor networks into a determined contracted tensor network;
determine, for each contraction expression, a contraction cost for contracting the respective tensor network into the determined contracted tensor network based on a cost function;
select (the contraction expression with the lowest contraction cost; and
contract each tensor network of the one or more tensor networks into the determined contracted tensor network based on the selected contraction expression;
wherein the cost function is based on at least on of:
a first parameter indicating an amount of memory required for contracting the respective tensor network into the determined contracted tensor network;
a second parameter indicating a computational complexity required for contracting the respective tensor network into the determined contracted tensor network; and
a third parameter indicating a number of read-write operations required for contracting the respective tensor network into the determined contracted tensor network.

2. The processor according to claim 1, wherein the one or more tensor networks have the same graph representation.

3. The processor according to claim 1, wherein the cost function is based on an arithmetic intensity, which is defined by a ratio of the second parameter and the third parameter.

4. The processor according to claim 1, wherein the cost function ƒ( [symbol] ) is determined by:
$$f ( 𝒯 ) := βmax ( {log}_{2} ( \frac{M}{{M}_{max}} ) , 0 ) + {log}_{2} ( C + α \cdot RW ) α$$
wherein M is the first parameter, C is the second parameter, RW is the third parameter, Mₘₐₓ is an upper memory amount limit, is the arithmetic intensity, and β is a penalty factor for controlling the weight of the first parameter.
α

[symbol]

5. The processor according to claim 1, wherein performing the local search algorithm to determine the plurality of contraction expressions comprises applying a plurality of local transformations, the plurality of local transformations including at least one of the following local transformations from a first contraction expression to a second contraction expression:
from (a*b)*c to (c*b)*a;
from (a*b)*c to (a*c)*b;
from a*(b*c) to b*(a*c);
from a*(b*c) to c*(b*a);
wherein a, b, and c are tensors of the respective tensor network and, * denotes a convolution operation.

6. The processor according to claim 1, wherein the local search algorithm comprises one of a hill climbing algorithm or a simulated annealing algorithm.

7. The processor according to claim 1, wherein:
the respective tensor network has a graph representation comprising a vertex for each tensor of the respective tensor network and at least one edge for each tensor leg of each tensor, and
the processor is further configured to perform a slicing operation during the local search algorithm by fixing a set of tensor legs in the respective tensor network.

8. The processor according to claim 7, configured to update the fixed set of tensor legs after a determined number of steps of performing the local search algorithm by at least one of removing a random tensor leg from the fixed set and adding a tensor leg resulting in the largest reduction of the first parameter to the fixed set.

9. The processor according to claim 1, further configured to select the same contraction expression with the lowest contraction cost for contracting in parallel each of multiple tensor networks having the same graph representation into the determined contracted tensor network.

10. The processor according to claim 1, wherein at least one of:
each contraction expression comprises at least one convolution of two tensors of the respective tensor network of the one or more tensor networks; and
determining a contraction cost of a contraction expression comprises performing at least one convolution of two tensors of the respective tensor network of the one or more tensor networks.

11. The processor according to claim 10, configured to save a convolution result of determining a convolution of two tensors of the respective tensor network in a cache.

12. The processor according to claim 11, configured to reuse a convolution result, which was saved while contracting a first tensor network, when contracting a second tensor network.

13. A quantum simulator for simulating a quantum circuit, wherein the quantum simulator comprises a non-transitory memory storing instructions and a processor for a quantum simulator, wherein when the processor executes the instructions, the quantum simulator is configured to:
perform a local search algorithm to determine a plurality of contraction expressions, wherein each contraction expression is suitable to contract a respective tensor network of one or more tensor networks into a determined contracted tensor network;
determine, for each contraction expression, a contraction cost for contracting the respective tensor network into the determined contracted tensor network based on a cost function;
select (the contraction expression with the lowest contraction cost; and
contract each tensor network of the one or more tensor networks into the determined contracted tensor network based on the selected contraction expression;
wherein the cost function is based on at least on of:
a first parameter indicating an amount of memory required for contracting the respective tensor network into the determined contracted tensor network;
a second parameter indicating a computational complexity required for contracting the respective tensor network into the determined contracted tensor network; and
a third parameter indicating a number of read-write operations required for contracting the respective tensor network into the determined contracted tensor network.

14. The quantum simulator according to claim 13, configured to simulate a quantum circuit, wherein simulating the quantum circuit comprises contracting one or more tensor networks into the determined contracted tensor network.

15. The quantum simulator according to claim 13, configured to perform a verification of a quantum circuit by finding an amplitude of each of multiple samples produced by the quantum circuit.

16. The quantum simulator according to claim 13, configured to determine a linear cross-entropy benchmarking of a bit string including a plurality of samples produced by a quantum circuit.

17. A processing method for a quantum simulator, wherein the method comprises:
performing a local search algorithm to determine a plurality of contraction expressions, wherein each contraction expression is suitable to contract a respective tensor network of one or more tensor networks into a determined contracted tensor network;
determining, for each contraction expression, a contraction cost for contracting the respective tensor network into the determined contracted tensor network based on a cost function;
selecting the contraction expression with the lowest contraction cost; and
contracting each tensor network of the one or more tensor networks into the determined contracted tensor network based on the selected contraction expression;
wherein the cost function is based on at least:
a first parameter indicating an amount of memory required for contracting the respective tensor network into the determined contracted tensor network;
a second parameter indicating a computational complexity required for contracting the respective tensor network into the determined contracted tensor network; and
a third parameter indicating a number of read-write operations required for contracting the respective tensor network into the determined contracted tensor network.
